(19) United States
(12) Patent Application Publication
(10) Pub. No.: US 2016/0333755 A1
(43) Pub. Date: Nov. 17, 2016

(54) OIL SEPARATOR

(71) Applicant: AISIN SEIKI KABUSHIKI KAISHA, Kariya-shi, Aichi, OT (JP)

(72) Inventor: Naoki Kira, Kariya-shi, Aichi (JP)

(73) Assignee: AISIN SEIKI KABUSHIKI KAISHA, Kariya-shi, Aichi, OT (JP)

(21) Appl. No.: 15/110,606

(22) PCT Filed: Dec. 24, 2014
(86) PCT No.: PCT/JP2014/084130

§ 371 Date: Jul. 8, 2016

(30) Foreign Application Priority Data
Jan. 27, 2014 (JP) 2014-012464

(51) Int. Cl. F01M 13/04; B01D 46/00; F02F 7/00

(52) U.S. Cl. CPC F01M 13/0416; F02F 7/006; B01D 46/0036; B01D 46/0031; F01M 2013/0438

(57) ABSTRACT

An oil separator is configured in which oil collecting performance is maintained at a high level even when negative pressure acts on a blow-by gas circulation portion. An oil discharge port for discharging oil collected from oil mist downward is formed in a bottom portion of the blow-by gas circulation portion, in which blow-by gas flows. A concave portion, which suppresses a phenomenon in which an air current spreads along a wall portion when that air current flows upward from the oil discharge port due to the action of negative pressure, is formed in a wall portion that opposes the oil discharge port.

### TECHNICAL FIELD

The present invention relates to an oil separator, and specifically relates to an improvement for an oil separator that collects oil from oil mist contained in blow-by gas.

### BACKGROUND ART

Patent Document 1 discloses a configuration of an oil separator in which a separator chamber has a blow-by gas inlet and a blow-by gas outlet, and a primary collision plate, a partition wall, and a secondary collision plate are arranged inside the separator chamber along the gas flow direction in the stated order. In this configuration, an oil drain pipe, which is for collecting oil and discharging it by causing it to drip into the cylinder head space, is formed in the bottom surface portion of the separator chamber.

In the oil separator of Patent Document 1, the separation of oil from the oil mist and the downward flow of separated-out oil are promoted by the oil mist colliding with the primary collision plate, the partition wall, and the secondary collision plate. In this configuration, gas passages are formed in the two side portions of the collision plates in order to prevent oil from being caught up again when blow-by gas passes over.

Patent Document 2 discloses an oil separator that uses multiple cyclones. In this oil separator, blow-by gas that has flowed in through a gas introducing port passes through a straightening chamber and is then introduced to cyclones that are arranged side-by-side in a single line, and, due to centrifugal force that accompanies a circulation current formed inside the cyclones, oil in an oil mist in the blow-by gas is caused to coagulate and be collected.

### CITATION LIST

### Patent Literature

Patent Document 1: JP 2009-121281 A

Patent Document 2: JP 4510108B

### SUMMARY OF INVENTION

### Technical Problem

Blow-by gas produced in the crankcase of an internal combustion engine contains uncombusted gas and oil mist from engine oil, and thus is supplied to the combustion chamber of the internal combustion engine and caused to undergo combustion along with an air-fuel mixture, instead of being discharged as-is into the atmosphere.

Also, in the case where blow-by gas that contains oil mist is caused to undergo combustion along with an air-fuel mixture in the combustion chamber of an internal combustion engine, the emission quality becomes worse, and reduction in the amount of engine oil is promoted. Accordingly, the oil contained in the blow-by gas is collected by an oil separator and returned to the internal combustion engine as disclosed in Patent Documents 1 and 2 and the like.

The oil separator is arranged in the path along which blow-by gas is returned to the intake system of the internal combustion engine, and therefore negative pressure from the intake system acts on the blow-by gas circulation portion in the oil separator at the air intake timing of the internal combustion engine. Also, in an oil separator configured such that oil is collected from oil mist contained in blow-by gas sent to the blow-by gas circulation portion, and the oil is discharged, due to its own weight, from an oil discharge port formed in the bottom portion, there are cases where oil flows backward through the oil discharge port due to the action of negative pressure, and forms a mist again

In particular, in the case where negative pressure acts on the blow-by gas circulation portion, there are also cases where an air current is generated in which air is ejected from the oil discharge port, and there are also cases where that air current comes into forceful contact with the upper wall portion of the internal space, and leads to a phenomenon in which oil becomes diffused and forms a mist again.

In order to resolve such a problem, it is conceivable to provide an umbrella-shaped member that suppresses the ejection of air at a position in the vicinity of the region above the oil discharge port, or provide the oil discharge port with a check valve that switches to a closed state when subjected to negative pressure.

However, in the configuration in which an umbrella-shaped member is provided at a position in the vicinity of the region above the oil discharge port, not only does the number of parts increase, thus leading to increased structural complexity and a rise in cost, but also it has been thought that when the air ejection speed is high, such a configuration causes oil to become diffused, and instead leads to the oil forming a mist again. Also, in the configuration for providing a check valve as well, the number of parts increases, thus leading to increased structural complexity and a rise in cost, and therefore this configuration is not easily realized.

An object of the present invention is to achieve a rational configuration for an oil separator that maintains the oil collecting performance at a high level, even in the case of a configuration in which air flows backward from an oil discharge port, which is for discharging oil, when negative pressure acts on a blow-by gas circulation portion.

### Solution to Problem

A feature of one aspect of the present invention lies in the inclusion of: an oil discharge port that is provided in a bottom portion of a blow-by gas circulation portion in which blow-by gas of an internal combustion engine flows, and that discharges oil collected from oil mist contained in the blow-by gas downward from the bottom portion; and a concave portion formed in a wall portion of the blow-by gas circulation portion that opposes the oil discharge port, so as to immobilize an air current returning from the oil discharge port to the blow-by gas circulation portion.

In the case where an air current flows in a direction of returning from the oil discharge port to the blow-by gas circulation portion, as in a situation in which negative pressure acts on the blow-by gas circulation portion, there have been cases where oil that is to be discharged from the oil discharge port is ejected into the blow-by gas circulation portion along with the air current and reaches the wall portion on the upper side of the blow-by gas circulation portion. According to this configuration of the present invention, in the case where an air current is ejected from the oil discharge port, the air current is immobilized by the concave portion, thus suppressing the diffusion of oil and promoting the falling of the oil toward the oil discharge port due to its own weight, thus not leading to the problem of reducing the oil collection rate.

Also, when comparing a configuration in which a concave portion is formed in the wall portion of the blow-by gas circulation portion as in the present invention, and a configuration in which the concave portion is arranged at a position in the vicinity of the region above the oil discharge port, in the configuration of the present invention it is possible to decelerate the air current ejected from the oil discharge port by causing it to come into contact with blow-by gas and air in the blow-by gas circulation portion, and thereafter bring the air current into contact with the concave portion. According to this configuration, it is possible to suppress the dispersion of oil, simplify the configuration by eliminating the need for a frame, a stay, or the like for supporting the concave portion, suppress an increase in the number of parts, and also suppress a rise in cost.

Accordingly, an oil separator is configured that maintains the oil collecting performance at a high level, even in the case of a configuration in which air flows backward from the oil discharge port, which is for discharging oil, when negative pressure acts on the blow-by gas circulation portion.

In an aspect of the present invention, the concave portion may be constituted by a tube-shaped body that projects from the wall portion toward the oil discharge port.

According to this configuration, oil mist contained in an air current blown upward from the oil discharge port arrives at the inner portion of the tube-shaped body, and the flow of the air current outward is suppressed by the tube-shaped body. Also, oil contained in the oil mist becomes affixed to the inner wall of the tube-shaped body, flows downward along the inner surface of the inner wall, and can be returned to the oil discharge port. In this configuration, a concave portion can be formed so as to be integrated with the wall portion, and it is possible to suppress an increase in the number of parts, and also further suppress a rise in cost.

In an aspect of the present invention, an oil inducing protrusion portion that projects downward in a tapered shape from an opening edge of the tube-shaped body may be formed.

According to this configuration, oil that has become affixed to the inner surface of the tube-shaped body and formed into droplets flows along the inner surface of the tube-shaped body due to its own weight, and can be further caused to fall downward from the oil inducing protrusion portion formed on the lower end of the opening edge. In other words, it is possible to cause the droplets of oil to fall at a predetermined position.

In an aspect of the present invention, the concave portion may be constituted by rib-shaped wall bodies that project from the wall portion into the blow-by gas circulation portion and extend between side wall portions connected to the wall portion at positions that sandwich the oil discharge port in a plan view.

According to this configuration, in the case where oil mist is blown upward from the oil discharge port along with an air current, a pair of the rib-shaped wall bodies suppress the diffusion of the oil mist ejected along with the air current, thus improving the oil collection rate. Also, the rib-shaped wall bodies cause the blow-by gas flowing in the blow-by gas circulation portion to become stagnated, and promotes the formation of droplets of oil from the oil mist.

In an aspect of the present invention, the concave portion may be constituted by a groove-shaped portion that recedes in a concave manner from the wall portion and extends between side wall portions connected to the wall portion at a position above the oil discharge port in a plan view.

According to this configuration, in the case where oil is blown upward from the oil discharge port along with an air current, the air current flows into the inner portion of the groove-shaped portion, thus suppressing the diffusion of the oil mist, and thereby improving the oil collection rate.

In an aspect of the present invention, an absorbent material that can absorb oil may be provided in an inner portion of the tube-shaped body.

According to this configuration, an air current blown upward from the oil discharge port into the inner portion of the tube-shaped body is decelerated by coming into contact with the absorbent material, and oil contained in the oil mist is absorbed by the absorbent material. Accordingly, it is possible to suppress the dispersion of oil, as well as cause the oil to be absorbed by the absorbent material and then drip.

### BRIEF DESCRIPTION OF DRAWINGS

FIG. 1 is a cross-sectional view of an engine.

FIG. 2 is a vertical cross-sectional side view of an oil separator.

FIG. 3 is a partial cutout plan view of the oil separator.

FIG. 4 is a perspective view of a tube-shaped body.

FIG. 5 is a cross-sectional view of a tube-shaped body according to another embodiment (a).

FIG. 6 is a perspective view of the tube-shaped body according to the other embodiment (a).

FIG. 7 is a vertical cross-sectional side view of an oil separator according to another embodiment (b).

FIG. 8 is a vertical cross-sectional side view of an oil separator according to another embodiment (c).

FIG. 9 is a partial cutout plan view of the oil separator according to the other embodiment (c).

FIG. 10 is a perspective diagram showing rib-shaped wall bodies according to the other embodiment (c).

FIG. 11 is a vertical cross-sectional side view of an oil separator according to another embodiment (d).

FIG. 12 is a partial cutout plan view of the oil separator according to the other embodiment (d).

### DESCRIPTION OF EMBODIMENTS

Hereinafter, embodiments of the present invention will be described with reference to the drawings.

[Basic Configuration]

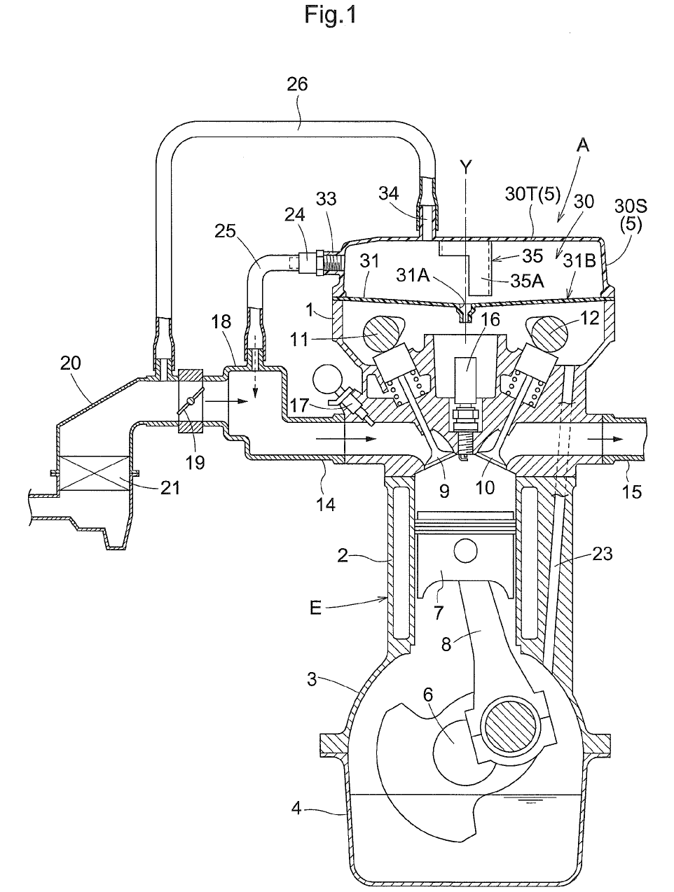

FIG. 1 shows a cross-section of an engine E (one example of an internal combustion engine) that includes a blow-by gas reducing apparatus A. The engine E is a four-cycle type of engine provided in a vehicle such as a passenger vehicle.

The engine E has a cylinder head 1 in a top portion, a cylinder block 2 that is coupled to the cylinder head 1, a crankcase 3 and an oil pan 4 that are coupled to the cylinder block 2, and a head cover 5 that is coupled to the cylinder head 1 at a position that covers the upper portion thereof. A crank shaft 6 is rotatably supported to the crankcase 3, a piston 7 is housed inside a cylinder bore formed in the cylinder block 2, and the piston 7 and the crank shaft 6 are coupled to each other by a connecting rod 8.

An air intake valve 9 and an air exhaust valve 10 are openably provided in the cylinder head 1, and an air intake camshaft 11 that causes the air intake valve 9 to open and close and an air exhaust camshaft 12 that causes the air exhaust valve 10 to open and close are rotatably supported in a parallel state at positions above the valves.

An intake manifold 14 is coupled to the side surface of the cylinder head 1 on one side, and an exhaust manifold 15 is coupled to the side surface on the other side. An ignition plug 16 that ignites an air-fuel mixture in the combustion chamber is provided on the upper surface of the cylinder head 1, and an injector 17 that supplies fuel to the combustion chamber is provided in the air intake passage of the cylinder head 1. A surge tank 18 is provided upstream of the intake manifold 14, a throttle valve 19 is provided upstream of the surge tank 18, and an air filter 21 is provided in an air intake pipe 20 upstream of the throttle valve 19.

This engine E is configured such that by synchronous rotation of the air intake camshaft 11 and the air exhaust camshaft 12 in synchronization with rotation of the crank shaft 6, the air intake valve 9 opens and closes at a predetermined timing, and the air exhaust valve 10 opens and closes at a predetermined timing.

Furthermore, a control apparatus such as an ECU performs control for causing fuel to be injected into the combustion chamber by the injector 17 at the timing of opening of the air intake valve 9, and causing an air-fuel mixture in the combustion chamber to be ignited by the ignition plug 16 at the timing when the air-fuel mixture is compressed. The engine E is configured such that the piston 7 moves downward along with combustion of the air-fuel mixture due to the ignition, and the air exhaust valve 10 opens when the piston 7 subsequently rises.

In the compression stroke of the engine E, blow-by gas is produced due to uncombusted gas leaking from between the cylinder bore and the piston 7 into the crankcase 3. Also, when the engine E is running, oil in the oil pan 4 is supplied in a manner of being sprayed onto the inner circumferential surface of the cylinder bore, and thus an oil mist exists in the space inside the crankcase 3.

For this reason, a large amount of oil mist is contained in the blow-by gas, and an oil separator 30 for removing oil is provided in the blow-by gas reducing apparatus A that returns blow-by gas to the intake system of the engine E. The following describes the configurations of the blow-by gas reducing apparatus A and the oil separator 30.

[Blow-by Gas Reducing Apparatus]

The blow-by gas reducing apparatus A is constituted by a gas extraction passage 23, the oil separator 30, a PCV valve 24, a gas reduction passage 25, and an introduction passage 26.

The gas extraction passage 23 is formed as a hole in a component of the engine E in order to supply blow-by gas from the interior of the crankcase 3 to the interior of the head cover 5. This gas extraction passage 23 does not need to be formed as a hole in the cylinder block 2 or the cylinder head 1, and a configuration is possible in which a flexible tube, a metal tube, or the like, which guides blow-by gas from the interior of the crankcase 3, is provided on the outer side of the engine E, for example.

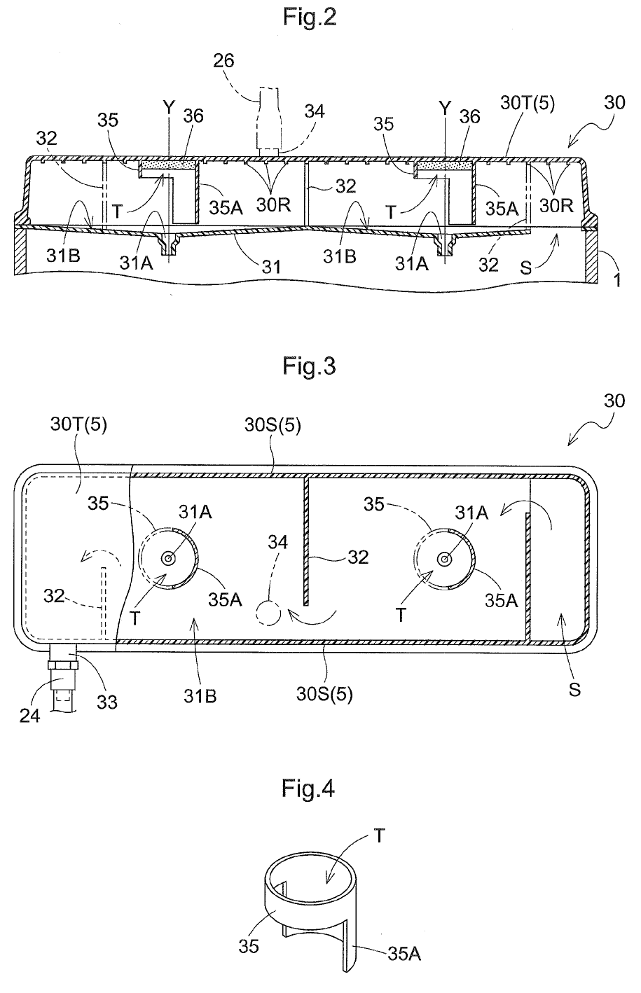

As shown in FIGS. 1 to 4, the oil separator 30 has a function for separating and collecting oil from oil mist contained in blow-by gas, and is provided inside the head cover 5. The PCV valve 24 functions as a check valve that switches from a closed state to an open state when subjected to negative pressure from the intake system.

The gas reduction passage 25 is constituted as a duct that supplies blow-by gas in the blow-by gas circulation portion, which is formed inside the oil separator 30, to the surge tank 18 of the intake manifold 14 via the PCV valve 24. The introduction passage 26 is constituted as a duct that puts the air intake pipe 20 and the blow-by gas circulation portion of the oil separator 30 into communication.

The gas extraction passage 23, the PCV valve 24, and the gas reduction passage 25 are referred to as a PCV (Positive Crankcase Ventilation) passage.

In this blow-by gas reducing apparatus A, when the engine E runs with a low load, blow-by gas in the oil separator 30 is supplied from the gas reduction passage 25 of the PCV passage to the surge tank 18, and air in the air intake pipe 20 is supplied to the oil separator 30 via the introduction passage 26 of the PCV passage. The blow-by gas returned to the intake system of the engine E via the gas reduction passage 25 undergoes combustion along with an air-fuel mixture in the combustion chamber. Also, the blow-by gas is diluted due to the supply of air into the oil separator 30 via the introduction passage 26.

When the engine E runs with a high load, similarly to the case of a low load, blow-by gas is supplied from the gas reduction passage 25 to the surge tank 18, and, along with this supply, blow-by gas in the oil separator 30 is supplied to the air intake pipe 20 via the introduction passage 26. The blow-by gas supplied in this manner undergoes combustion along with an air-fuel mixture in the combustion chamber of the engine E.

[Blow-by Gas Reducing Apparatus: Oil Separator]

The oil separator 30 is configured to include a bottom wall 31 (specific example of a bottom portion) arranged at a position that partitions the space above the cylinder head 1 in the head cover 5, and include multiple control plates 32 that control the flow of blow-by gas. An introducing port S, which is for introducing blow-by gas from the lower space into the blow-by gas circulation portion, is formed in the bottom wall 31. Also, the blow-by gas circulation portion is formed inside the oil separator 30, and multiple oil discharge ports 31A for discharging collected oil downward and an inclined surface 31B for guiding collected oil to the oil discharge ports 31A are formed in the bottom wall 31.

In this oil separator 30, the upper surface of the head cover 5 is considered to be an upper wall 30T (specific example of a wall portion) of the oil separator 30, and side surfaces of the head cover 5 that are connected to the upper wall 30T are considered to be side walls 30S (specific example of a side wall portion) of the oil separator 30. A large number of ribs 30R are formed on the inner surface of the upper wall 30T in a parallel orientation, and in a manner of protruding into the blow-by gas circulation portion.

Also, the PCV valve 24 for feeding blow-by gas is attached to an air exhaust hole 33 in the upper wall 30T, and the gas extraction passage 23 is connected to the PCV valve 24. The introduction passage 26 is connected to a communication hole 34 in the upper wall 30T.

In this oil separator 30, a cylindrical tube-shaped body 35, which is centered about a vertical discharge port axis Y that passes through the center of the oil discharge port 31A, is formed so as to be integrated with the upper wall 30T serving as the wall portion that opposes the oil discharge port 31A, and a concave portion T is configured by the interior space of the tube-shaped body 35. An absorbent material 36 made up of a sponge, non-woven cloth, or the like that absorbs oil is provided in the inner portion (concave portion T) of the tube-shaped body 35.

Specifically, the head cover 5 (upper wall 30T, side walls 30S) and the bottom wall 31 are resin molded parts, and the tube-shaped body 35 is formed so as to be integrated with the lower surface side of the upper wall 30T. Also, the control plates 32 are formed so as to be integrated with either the upper wall 30T or the bottom wall 31. The tube-shaped body 35 is shaped so as to be open downward, and is arranged so as to be in a region that surrounds the oil discharge port 31A in a plan view.

The tube-shaped body 35 is molded in a shape in which the portion connected to the upper wall 30T is cylindrical, and a projection portion 35A shaped so as to protrude downward from a portion of the cylindrical portion is formed so as to be integrated with the cylindrical portion. The projection portion 35A is arranged at a position for blocking the flow of blow-by gas. The protruding end of the projection portion 35A may be configured so as to be in contact with the bottom wall 31, or configured so as to be separated from and above the bottom wall 31.

The plan-view shape of the tube-shaped body 35 that constitutes the concave portion T is not limited to being a circle, and may be a rectangular shape such as a square shape, or may be a polygonal shape such as a pentagonal or hexagonal shape. The tube-shaped body 35 may be attached to the upper wall 30T by a heat welding or screw fastening technique.

[Collection of Oil by Oil Separator]

According to the above configuration, negative pressure is generated in the intake manifold 14, the PCV valve 24 opens, and blow-by gas in the blow-by gas circulation portion of the oil separator 30 is fed to the gas reduction passage 25. Accordingly, the blow-by gas in the blow-by gas circulation portion circulates, and blow-by gas in the crankcase 3 is drawn from the introducing port S into the blow-by gas circulation portion. Note that in the case where the engine E is running with a lower load, air is suctioned from the intake system into the blow-by gas circulation portion via the introduction passage 26, and the blow-by gas becomes diluted.

Due to the provision of the control plates 32 in the blow-by gas circulation portion, the blow-by gas flows in a manner of being controlled by the control plates 32 as shown by arrows in FIG. 3. As the blow-by gas flows, particles of oil in the oil mist become affixed to the surfaces of the control plates 32 and the surfaces of the ribs 30R and drip, and particles of oil grow in stagnant portions in the blow-by gas flow and drip. Oil that has dripped and become collected in this manner then flows along the inclined surface 31B of the bottom wall 31 and is discharged in a manner of falling downward through the oil discharge port 31A.

When the engine E is running, the negative pressure acting on the gas reduction passage 25 increases and decreases in a pulsating manner, and therefore as the negative pressure rises, an air current flowing backward from the oil discharge port 31A toward the blow-by gas circulation portion is generated, and there are cases where oil that is about to be discharged from the oil discharge port 31A is blown upward along the discharge port axis Y and reaches the upper wall 30T.

In the case where the air current reaches the concave portion T of the tube-shaped body 35 in this way, the tube-shaped body 35 suppresses the flow in the direction conforming to the upper wall 30T, and thus the diffusion of oil is suppressed. Also, due to the absorbent material 36 being provided inside the tube-shaped body 35, the flow speed of the air current is reduced due to coming into contact with the absorbent material 36, the dispersion of oil is suppressed, and oil contained in the air current is absorbed by the absorbent material 36.

Particles of oil become affixed to the inner circumferential surface of the tube-shaped body 35, and, due to coming into contact with oil mist, grow as time elapses and fall in the vicinity of the oil discharge port 31A. As described above, the projection portion 35A is formed on the tube-shaped body 35, and therefore there is no problem of the falling of the oil being inhibited by the flow of blow-by gas.

Note that some of the oil discharged downward from the oil discharge port 31A flows from the upper portion of the cylinder head 1 into the gas extraction passage 23 and is returned to the oil pan 4, and residual oil is returned from a blow-by gas circulation portion such as the chain case connected to the upper portion of the cylinder head 1, to the oil pan 4.

[Oil Separator Variations]

In the oil separator 30 of the present embodiment, by arranging multiple control plates 32 in the blow-by gas circulation portion, the length of the flow path of blow-by gas increases, and stagnant portions are created at the same time, thus realizing the collection of oil contained in oil mist. In the present invention, in place of this, the collection of oil may be realized by using partition walls in which pores are formed, and using collision plates in which protruding and receding surfaces are formed, as disclosed in Patent Document 1 (JP 2009-121281A).

Also, as a configuration for collecting oil from oil mist, a cyclone-type configuration is possible in which oil is collected by causing blow-by gas to circulate, as disclosed in Patent Document 2 (JP 4510108B). Furthermore, a configuration is possible in which oil mist is collected using a mesh filter as disclosed in JP 2012-26321A.

An oil guiding plate that recovers oil at a position farther below the bottom wall 31 and discharges it to a predetermined position may be arranged as the oil separator 30. With this configuration that includes a guiding plate, in the case where negative pressure is generated, it is possible to suppress a phenomenon in which air flows toward the oil discharge port 31A, and it is possible to suppress an increase in the flow speed of the air current ejected from the oil discharge port 31A.

### Actions and Effects of Present Embodiment

By configuring the oil separator 30 as described above, even if oil that is to be discharged from the oil discharge port 31A is ejected into the blow-by gas circulation portion along with an air current due to negative pressure acting on the blow-by gas circulation portion, the air current is fed into the concave portion T of the tube-shaped body 35, thus suppressing a phenomenon in which the air current flows along the upper wall 30T.

Also, the tube-shaped body 35 is supported on the upper wall 30T, and therefore it is possible to increase the relative distance between the tube-shaped body 35 and the oil discharge port 31A. Accordingly, compared to the case where, for example, a member for suppressing ejection is arranged at a position in the vicinity of the region above the oil discharge port 31A, an air current ejected from the oil discharge port 31A is decelerated by coming into contact with blow-by gas and air in the blow-by gas circulation portion, and is thereafter introduced into the tube-shaped body 35 and brought into contact with the tube-shaped body 35, thus making it possible to suppress the dispersal of oil. Also, due to the absorbent material 36 being provided inside the tube-shaped body 35, the flow speed of the air current is reduced due to coming into contact with the absorbent material 36, the dispersion of oil is suppressed, and oil contained in the air current is efficiently absorbed by the absorbent material 36.

Specifically, this promotes the falling of oil from the inner portion of the tube-shaped body 35 to the oil discharge port 31A due to its own weight, and improves the oil collection rate. In this way, an oil separator is configured that, while having a simple configuration in which air flows backward from the oil discharge port 31A, which is for discharging oil, when negative pressure acts on the blow-by gas circulation portion, maintains the oil collecting performance at a high level without being provided with a check valve, a member for suppressing the ejection of an air current from the oil discharge port 31A, or the like.

Also, the projection portion 35A formed on the tube-shaped body 35 is arranged at a position for blocking the flow of blow-by gas, thus causing oil that drips from the inner circumferential surface of the tube-shaped body 35 to appropriately fall in the vicinity of the oil discharge port 31A, and realizing a further improvement in the oil recovery rate.

### Other Embodiments

Besides the embodiment described above, the present invention may be configured as described below.

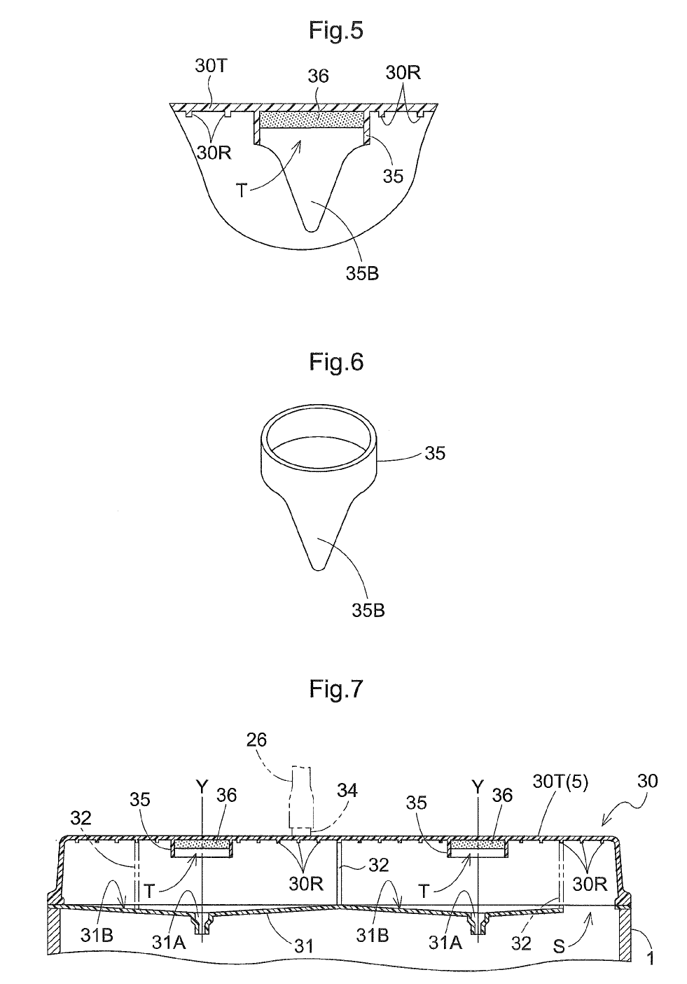

(a) As shown in FIGS. 5 and 6, an oil inducing protrusion portion 35B that projects downward in a tapered shape may be formed on the opening edge of the tube-shaped body 35 that constitutes the concave portion T. By forming the oil inducing protrusion portion 35B in this manner, particles of oil that are affixed to the inner circumferential surface of the tube-shaped body 35 can be caused to move along the oil inducing protrusion portion 35B, and drip to a specific position in the vicinity of the oil discharge port 31A, thus being favorably discharged. In the configuration of this other embodiment (a) as well, an absorbent material 36 similar to that in the embodiment is provided at a position above the oil discharge port 31A.

(b) As shown in FIG. 7, the tube-shaped body 35 constituting the concave portion T may be formed in a simple tube shape, without being provided with the projection portion 35A shown in the embodiment. In this configuration, the tube-shaped body 35 has a shape in which the lower end thereof is cut along a plane orthogonal to the discharge port axis Y, thus facilitating production. Also, in the configuration of this other embodiment (b) as well, an absorbent material 36 similar to that in the embodiment is provided at a position above the oil discharge port 31A.

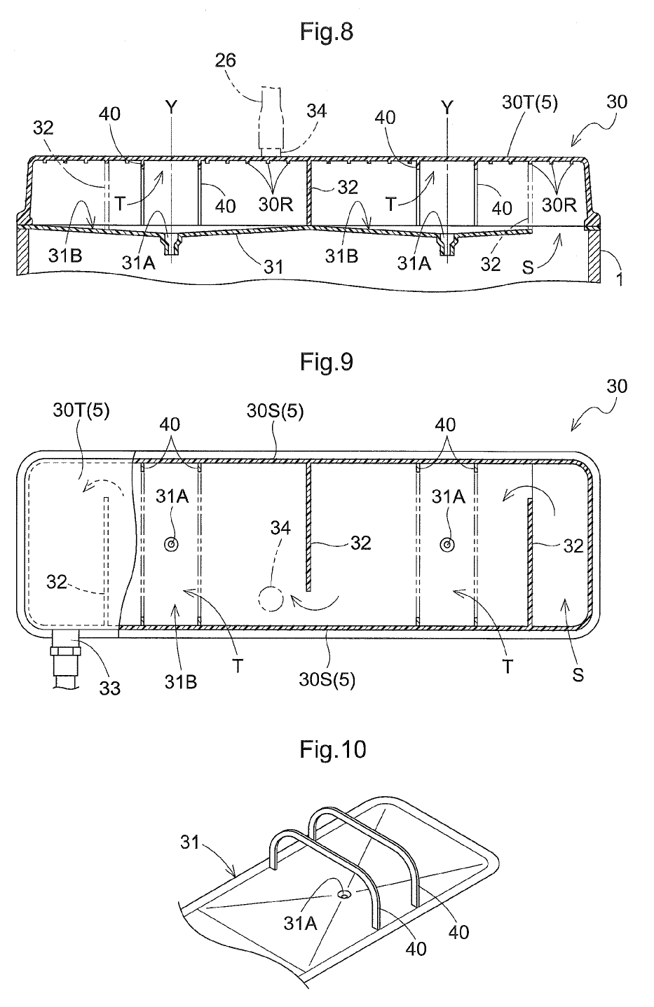

(c) As shown in FIGS. 8 to 10, the concave portion T of the oil separator 30 is constituted by a pair of rib-shaped wall bodies 40 that project from the upper wall 30T into the blow-by gas circulation portion and extend between the side walls 30S at positions that sandwich the oil discharge port 31A in a plan view (a view in the direction along the discharge port axis Y).

In this other embodiment (c), even in the case where negative pressure acts on the blow-by gas circulation portion of the oil separator 30, and an air current is blown upward from the oil discharge port 31A, the air current is fed into the concave portion Tat a position between the pair of rib-shaped wall bodies 40, thus favorably suppressing the phenomenon in which oil is diffused and dispersed. In this configuration, the rib-shaped wall bodies 40 are provided on the side walls 30S in an orientation of protruding into the blow-by gas circulation portion, thus making it possible to promote the collection of oil by causing the blow-by gas to become stagnant and causing particles in the oil mist to become affixed to the rib-shaped wall bodies 40.

Note that in this other embodiment (c), the rib-shaped wall bodies 40 may be formed in only a region that extends from the upper wall 30T to a portion of the side walls 30S, and an absorbent material 36 similar to that of the embodiment may be provided at a position above the oil discharge port 31A.

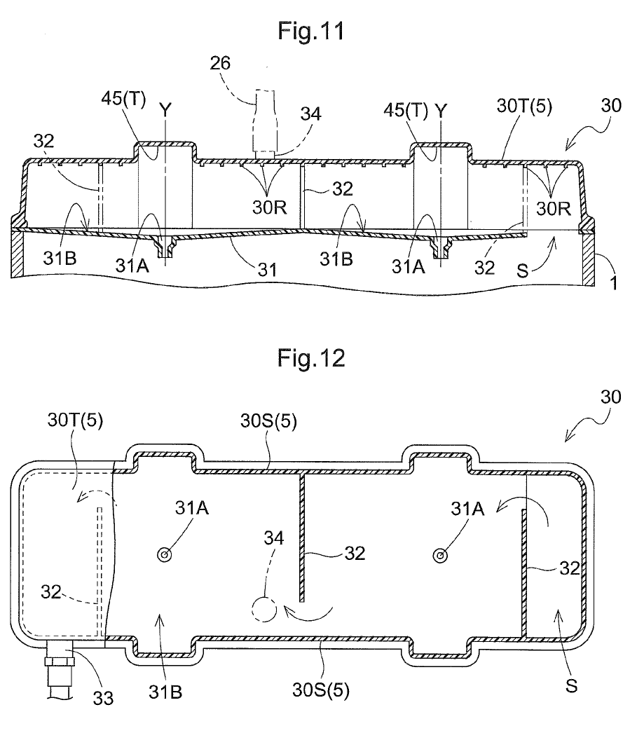

(d) As shown in FIGS. 11 and 12, the concave portion T may be constituted by a groove-shaped portion 45 that recedes in a concave manner from the upper wall 30T and extends between the side walls 30S at a position above the oil discharge port 31A in a plan view (a view in the direction along the discharge port axis Y).

In this other embodiment (d), even in the case where negative pressure acts on the blow-by gas circulation portion of the oil separator 30, and an air current is blown upward from the oil discharge port 31A, the air current is fed into the inner portion of the groove-shaped portion 45, thus favorably suppressing the phenomenon in which oil is diffused and dispersed.

Note that in this other embodiment (d), the groove-shaped portion 45 may be formed in only a region that extends from the upper wall 30T to a portion of the side walls 30S, and an absorbent material 36 similar to that of the embodiment may be provided at a position above the oil discharge port 31A.

(e) Instead of a configuration in which a portion of the head cover 5 is also used as the oil separator 30 as in the embodiment, the oil separator 30 may be given an independent structure. Accordingly, it is possible to create a configuration for collecting oil without being limited by the size of the head cover 5, and it is possible to improve the oil collecting performance.

### INDUSTRIAL APPLICABILITY

The present invention can be used as an oil separator in which an oil discharge port for discharging oil is formed in a bottom portion.

### REFERENCE SIGNS LIST

30S: side wall portion (side wall)

30T: wall portion (upper wall)

31: bottom portion (bottom wall)

31A: oil discharge port

35: tube-shaped body

35B: oil inducing protrusion portion

36: absorbent material

40: concave portion (rib-shaped wall body)

45: concave portion (groove-shaped portion)

E: internal combustion engine (engine)

T: concave portion

1. (canceled)

2. (canceled)

3. (canceled)

4. (canceled)

5. (canceled)

6. (canceled)

7. An oil separator comprising:
an oil discharge port that is provided in a bottom portion of a blow-by gas circulation portion in which blow-by gas of an internal combustion engine flows, and that discharges oil collected from oil mist contained in the blow-by gas downward from the bottom portion; and
a concave portion formed in a wall portion of the blow-by gas circulation portion that opposes the oil discharge port, so as to immobilize an air current returning from the oil discharge port to the blow-by gas circulation portion,
wherein the concave portion is arranged in a region that surrounds the oil discharge port in a plan view.

8. The oil separator according to claim 7, wherein the concave portion is constituted by a tube-shaped body that projects from the wall portion toward the oil discharge port.

9. The oil separator according to claim 8, wherein an oil inducing protrusion portion that projects downward in a tapered shape from an opening edge of the tube-shaped body is formed.

10. The oil separator according to claim 7, wherein the concave portion is constituted by rib-shaped wall bodies that project from the wall portion into the blow-by gas circulation portion and extend between side wall portions connected to the wall portion at positions that sandwich the oil discharge port in a plan view.

11. The oil separator according to claim 7, wherein the concave portion is constituted by a groove-shaped portion that recedes in a concave manner from the wall portion and extends between side wall portions connected to the wall portion at a position above the oil discharge port in a plan view.

12. The oil separator according to claim 8, wherein an absorbent material that can absorb oil is provided in an inner portion of the tube-shaped body.

13. The oil separator according to claim 9, wherein an absorbent material that can absorb oil is provided in an inner portion of the tube-shaped body.
